(19) United States
(12) Patent Application Publication
(10) Pub. No.: US 2025/0166877 A1
(43) Pub. Date: May 22, 2025

(54) COIL COMPONENT

(71) Applicant: SAMSUNG ELECTRO-MECHANICS CO., LTD., Suwon-si (KR)

(72) Inventors: Sang Jin KIM, Suwon-si (KR); Ju Hwan YANG, Suwon-si (KR); Boum Seock KIM, Suwon-si (KR); Byeong Cheol MOON, Suwon-si (KR); Han LEE, Suwon-si (KR)

(73) Assignee: SAMSUNG ELECTRO-MECHANICS CO., LTD., Suwon-si (KR)

(21) Appl. No.: 18/912,800

(22) Filed: Oct. 11, 2024

(30) Foreign Application Priority Data
Nov. 16, 2023 (KR) 10-2023-0159119

(51) Int. Cl. H01F 5/04; H01F 1/147; H01F 37/00

(52) U.S. Cl. CPC H01F 5/04; H01F 1/14766; H01F 37/00

(57) ABSTRACT

A coil component includes a body including an intermediate layer, and having a first surface and a second surface opposing each other, and a plurality of side surfaces connecting the first surface to the second surface; a first coil disposed in the body and including a first coil pattern having at least one turn; a second coil spaced apart from the first coil in the body and including a second coil pattern having at least one turn; first and second external electrodes disposed on the body and connected to the first coil; and third and fourth external electrodes disposed on the body and connected to the second coil, wherein the intermediate layer has permeability lower than permeability of the other region of the body, is disposed between the first coil and the second coil, and is spaced apart from each of the first coil and the second coil.

### CROSS-REFERENCE TO RELATED APPLICATION(S)

This application claims benefit of priority to Korean Patent Application No. 10-2023-0159119 filed on Nov. 16, 2023 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

In the case of a coupled inductor in which two or more magnetically coupled coils are disposed in a coil component, it may be necessary to control a distance between the two coils to adjust a coupling coefficient k.

However, in the case of a coupled inductor in which two coils are disposed in a vertical direction, a magnetic path passing between the two coils may be short such that a leakage path of magnetic flux may occur between the two coils, which may lower the coupling coefficient k.

In this case, when the distance between two coils is reduced to increase the coupling coefficient k, the saturation current Iₛₐₜ properties may deteriorate, and the implemented coupling coefficient k may also have the issue of increased volatility due to errors in processes.

### SUMMARY

An aspect of the present disclosure is to, by disposing an intermediate layer having low permeability between two coils of a coupled inductor and adjusting a thickness and a position of the intermediate layer, implement a desired coupling coefficient k.

Another aspect of the present disclosure is to, by appropriately maintaining a spacing distance between two coils in a coupled inductor, alleviate a decrease in saturation current Iₛₐₜ properties occurring when the two coils are close to each other or an increase in volatility of a coupling coefficient k caused by errors in process.

According to an aspect of the present disclosure, a coil component includes a body including an intermediate layer, the body having a first surface and a second surface opposing each other in a first direction, and a plurality of side surfaces connecting the first surface to the second surface; a first coil disposed in the body and including a first coil pattern having at least one turn; a second coil spaced apart from the first coil in the body and including a second coil pattern having at least one turn; first and second external electrodes disposed on the body and connected to the first coil; and third and fourth external electrodes disposed on the body and connected to the second coil, wherein the intermediate layer has permeability lower than permeability of the other region of the body, is disposed between the first coil and the second coil, and is spaced apart from each of the first coil and the second coil.

According to another aspect of the present disclosure, a coil component includes a body including an intermediate layer, the body having a first surface and a second surface opposing each other in a first direction, and a plurality of side surfaces connecting the first surface to the second surface; a first coil disposed in the body, and including a first coil pattern that has at least one turn and that is a single layer; a second coil spaced apart from the first coil in the body, and including a second coil pattern that has at least one turn and that is a single layer; first and second external electrodes disposed on the body and connected to the first coil; and third and fourth external electrodes disposed on the body and connected to the second coil, wherein the body includes an Fe-based alloy, and an Fe-based alloy included in the intermediate layer in the body and an Fe-based alloy included in the other region of the body other than the intermediate layer have different compositions, and wherein the intermediate layer is disposed between the first coil and the second coil, and spaced apart from the first coil and the second coil.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is an exploded perspective diagram illustrating a coupling relationship between a portion of components illustrated in FIG. 1;

FIG. 3 is a cross-sectional diagram taken along line I-I′ in FIG. 1;

FIG. 4 is an enlarged diagram illustrating region A illustrated in FIG. 3;

FIG. 5 is an enlarged diagram illustrating region B illustrated in FIG. 3;

FIG. 6 is an enlarged diagram illustrating a first modified example of region A illustrated in FIG. 3;

FIG. 7 is an enlarged diagram illustrating a second modified example of region A illustrated in FIG. 3;

FIG. 8 is a graph of coupling coefficient k depending on relative permeability and a thickness of an intermediate layer in a first embodiment of the present disclosure;

FIG. 9 is a perspective diagram illustrating a coil component according to a second embodiment of the present disclosure;

FIG. 10 is a cross-sectional diagram taken along line II-II′ in FIG. 9;

FIG. 11 is a graph of coupling coefficient k depending on relative permeability and a thickness of an intermediate layer in a second embodiment of the present disclosure;

FIG. 12 is a perspective diagram illustrating a coil component according to a third embodiment of the present disclosure;

FIG. 13 is a cross-sectional diagram taken along line III-III′ in FIG. 12;

FIG. 14 is a perspective diagram illustrating a coil component according to a fourth embodiment of the present disclosure;

FIG. 15 is a cross-sectional diagram taken along line IV-IV′ in FIG. 14;

FIG. 16 is a perspective diagram illustrating a coil component according to a fifth embodiment of the present disclosure;

FIG. 17 is an exploded perspective diagram of some of the components illustrated in FIG. 16;

FIG. 18 is a cross-sectional diagram taken along line V-V′ in FIG. 16;

FIG. 19 is a diagram illustrating a modified example in FIG. 18; and

FIG. 20 is a diagram illustrating another modified example in FIG. 18.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

The structures, shapes, and sizes described as examples in embodiments in the present disclosure may be implemented in another exemplary embodiment without departing from the spirit and scope of the present disclosure.

In the drawings, the T direction may be defined as a first direction or a thickness direction, the W direction may be defined as a second direction or a width direction, and the L direction may be defined as a third direction or a length direction.

In the drawings, the same elements will be indicated by the same reference numerals. Also, redundant descriptions and detailed descriptions of known functions and elements which may unnecessarily make the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

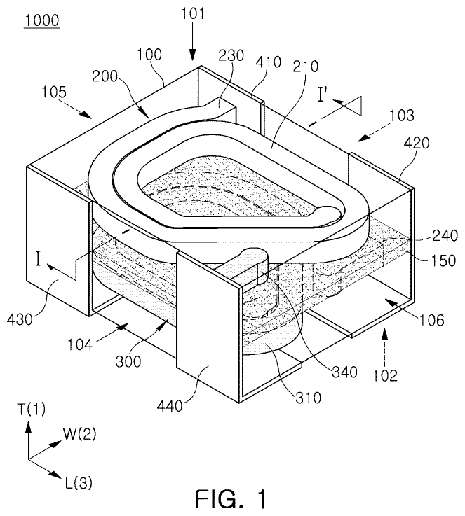

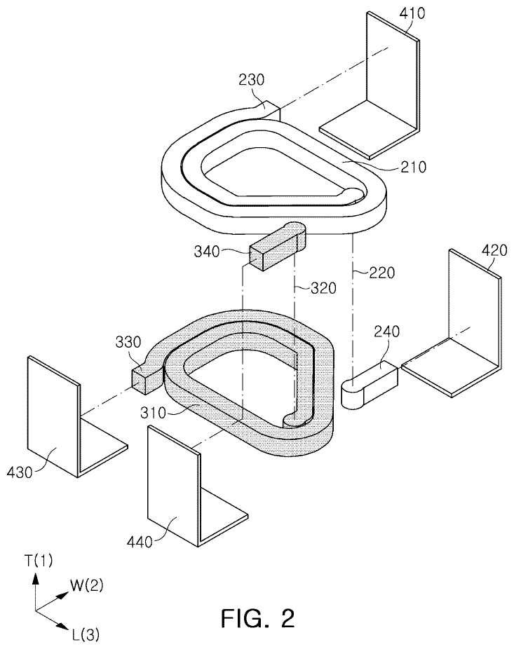

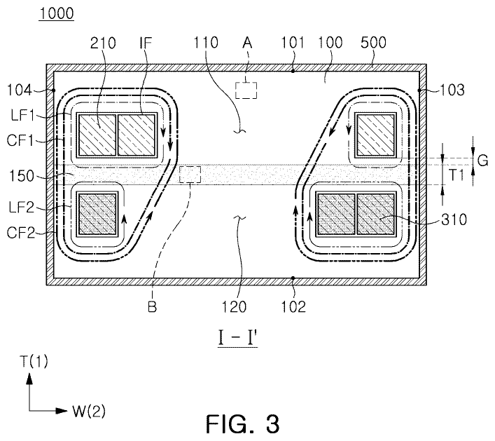

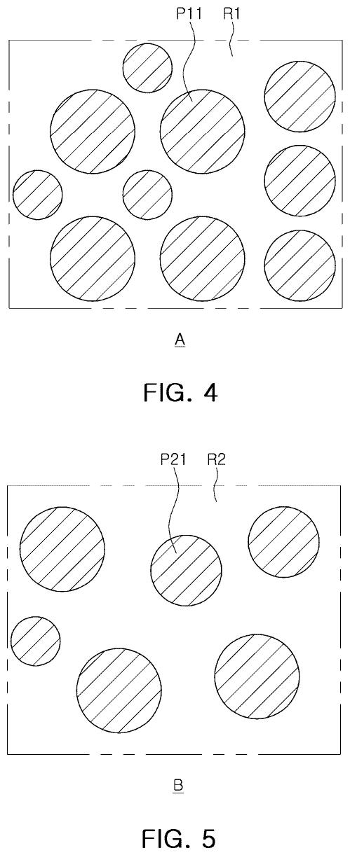

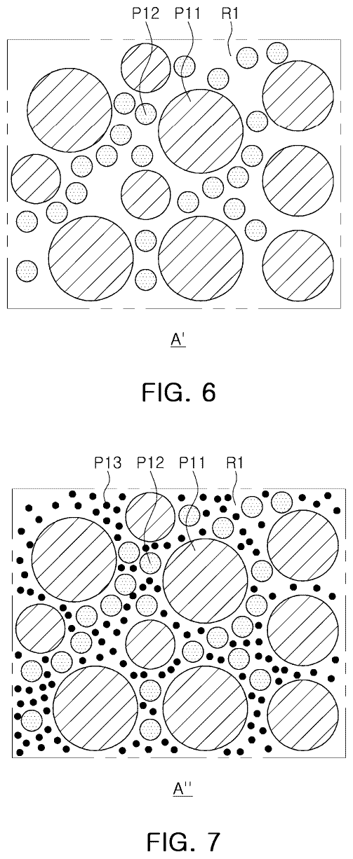

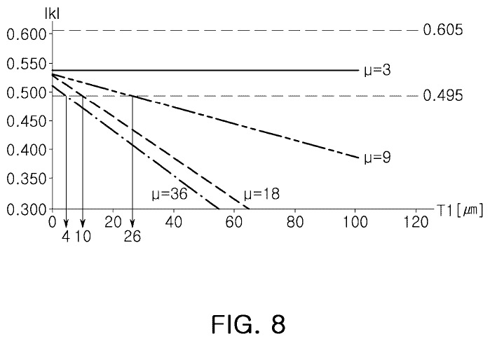

FIG. 1 is a perspective diagram illustrating a coil component 1000 according to a first embodiment. FIG. 2 is an exploded perspective diagram illustrating a coupling relationship between a portion of components illustrated in FIG. 1. FIG. 3 is a cross-sectional diagram taken along line I-I′ in FIG. 1. FIG. 4 is an enlarged diagram illustrating region A illustrated in FIG. 3. FIG. 5 is an enlarged diagram illustrating region B illustrated in FIG. 3. FIG. 6 is an enlarged diagram illustrating a first modified example of region A illustrated in FIG. 3. FIG. 7 is an enlarged diagram illustrating a second modified example of region A illustrated in FIG. 3. FIG. 8 is a graph of coupling coefficient k depending on relative permeability and a thickness of an intermediate layer in a first embodiment of the present disclosure.

In FIG. 1, an insulating layer 500 on a body 100 applied to the embodiment is not provided to illustrate the coupling relationship between the components clearly.

Referring to FIGS. 1 to 8, a coil component 1000 according to the first embodiment may include a body 100, first and second coils 200 and 300, and first to fourth external electrodes 410, 420, 430, and 440, and may further include an insulating layer 500 covering the body 100.

The first coil 200 and the second coil 300 in the embodiment may be spaced apart from each other in the first direction T in the body 100, such that the first coil 200 and the second coil 300 may be magnetically coupled to each other while energized, and may have a coupling coefficient k. Also, the first coil 200 may include a first coil pattern 210 having at least one turn, and the second coil 300 may include a second coil pattern 310 having at least one turn. Here, at least one of the first coil pattern 210 and the second coil pattern 310 may be formed as a single layer.

Also, the body 100 in the embodiment may include an intermediate layer 150 disposed between the first coil 200 and the second coil 300 and spaced apart from each of the first coil 200 and the second coil 300 at a predetermined distance G. The intermediate layer 150 may have lower permeability than permeability of the other region of the body 100.

The coil component 1000 may, by disposing the intermediate layer 150 having low permeability between the first coil 200 and the second coil 300 magnetically coupled to each other, implement coupling coefficient k in the desired range without excessively decreasing the distance between the first coil 200 and the second coil 300.

Also, the coil component 1000 according to the embodiment may be miniaturized by implementing each of the coil patterns 210 and 310 of the first and second coils 200 and 300, magnetically coupled to each other, as a single layer, and the intermediate layer 150 and the coil patterns 210 and 310 may be spaced apart from each other at the predetermined distance G, such that the coupling coefficient k may be finely adjusted. That is, by adjusting the permeability, the thickness T1 of the intermediate layer 150, and the distance between the intermediate layer 150 and the coil patterns 210 and 310, the leaked magnetic flux flowing between the first and second coil patterns 210 and 310 may be adjusted, such that the desired coupling coefficient k may be accurately implemented.

In the description below, main components included in the coil component 1000 according to the embodiment will be described in greater detail.

The body 100 may form an exterior of the coil component 1000 in the embodiment, may include the intermediate layer 150, and may include the first and second coils 200 and 300 embedded therein.

The body 100 may have a hexahedral shape.

The body 100 may include a first surface 101 and a second surface 102 opposing each other in the thickness direction T, a third surface 103 and a fourth surface 104 opposing each other in the width direction W, and a fifth surface 105 and a sixth surface 106 opposing each other in the length direction L. Each of the first to fourth surfaces 101, 102, 103 and 104 of the body 100 may be side surfaces of the body 100 connecting the first surface 101 to the second surface 102 of the body 100.

The body 100 may be formed such that the coil component in which the external electrodes 410, 420, 430, and 440 are formed may have a length of 2.5 μmm, a width of 2.0 μmm and a thickness of 0.8 μmm, may have a length of 2.0 μmm, a width of 1.2 mm and a thickness of 0.6 μmm, may a length of 1.6 μmm, a width of 0.8 μmm and a thickness of 0.4 μmm, may have a length of 1.4 μmm, a width of 1.2 μmm and a thickness of 0.65 μmm, may have a length of 1.0 μmm, a width of 0.7 μmm and a thickness of 0.65 μmm, may have a length of 0.8 μmm, a width of 0.4 μmm and a thickness of 0.65 μmm, or may have a length of 0.8 μmm, a width of 0.4 μmm and a thickness of 0.5 μmm, but an embodiment thereof is not limited thereto. As the above-described exemplary dimensions for the length, width and thickness of the coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other in parallel to the length direction L and spaced apart from each other in the thickness direction T, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other in parallel to the thickness direction T and spaced apart from each other in the length direction L, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other in parallel to the width direction W and spaced apart from each other in the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and a thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin.

The magnetic material may be ferrite or metallic magnetic powder.

Ferrite may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an embodiment thereof is not limited thereto.

Referring to FIG. 3, the body 100 may include a first core 110 filling a central region of the first coil pattern 210, and a second core 120 filling a central region of the second coil pattern 310.

The first and second cores 110 and 120 may be formed by filling the central region of each of the first and second coil patterns 210 and 310 with a magnetic composite sheet, but an embodiment thereof is not limited thereto.

The first core 110 and the second core 120 in the embodiment may include a region in which the first core 110 and the second core 120 overlap each other in the first direction T and a region in which the first core 110 and the second core 120 do not overlap each other in the first direction T.

The region in which the first core 110 and second core 120 overlap each other in the first direction T may be a region corresponding to the intersection of the region surrounded by the first coil pattern 210 and the region surrounded by the second coil pattern 310 overlapping each other in the first direction T.

Also, the region in which the first core 110 and the second core 120 do not overlap each other in the first direction T may be a region corresponding to a difference surrounded by only one of the first coil pattern 210 and the second coil pattern 310.

In other words, the coil component 1000 in the embodiment may include a shared core region in which the first core 110 and the second core 120 overlap each other in the first direction T, and the non-overlapping core region in which the first core 110 and the second core 120 do not overlap each other in the first direction T.

Referring to FIGS. 1 and 3, the body 100 in the embodiment may include an intermediate layer 150 disposed between the first coil pattern 210 and the second coil pattern 310, and spaced apart from each of the first coil pattern 210 and the second coil pattern 310.

The intermediate layer 150 may function to adjust the coupling coefficient k between the first coil 200 and the second coil 300 magnetically coupled to each other.

Referring to FIG. 3, when the coil component 1000 according to the embodiment is energized, a flow of magnetic flux may occur around the coil patterns 210 and 310. The magnetic flux generated from the first coil pattern 210 may flow into a leaked magnetic flux path LF1 around the first coil pattern 210, and a coupled magnetic flux path CF1 around the entirety of the first and second coil patterns 210 and 310.

Also, the magnetic flux generated in the second coil pattern 310 may flow into the leaked magnetic flux path LF2 around the second coil pattern 310, and the coupled magnetic flux path CF2 around the entirety of the first and second coil patterns 210 and 310.

Here, in a coupled inductor in which the first and second coil patterns 210 and 310 are spaced apart from each other in the vertical direction, the leaked magnetic flux path LF1 and LF2 may be shorter than in a coupled inductor sharing a turn, such that the leaked magnetic flux may increase, and accordingly, the coupling coefficient k may decrease.

To address the above issue, when the distance between the first and second coil patterns 210 and 310 is decreased, side effects such as a decrease in saturation current Iₛₐₜ properties or an increase in the volatility of coupling coefficient k due to errors in process may occur.

The coil component 1000 in the embodiment may, by disposing the intermediate layer 150 between the first and second coil patterns 210 and 310, and forming a spacing distance G between the intermediate layer 150 and the coil patterns 210 and 310, the desired coupling coefficient k may be finely adjusted without excessively reducing the distance between the first and second coil patterns 210 and 310.

Referring to FIGS. 1 and 3, at least a portion of the intermediate layer 150 in the embodiment may extend to a side surface of the body 100, that is, the third surface to the sixth surface 103, 104, 105, and 106.

In this case, body 100 may be divided into a region between one surface of the intermediate layer 150 and the first surface 101 of the body 100, and a region between the other surface of the intermediate layer 150 and the second surface 102 of the body 100.

The intermediate layer 150 in the embodiment may have lower permeability than permeability of the other region of the body 100. As an example, although not limited thereto, relative permeability of intermediate layer 150 may have a value less than 36.

FIG. 8 is a graph of coupling coefficient k depending on relative permeability and thickness T1 of an intermediate layer 150 in a first embodiment.

The desired coupling coefficient k in the coil component 1000 according to the embodiment may be −0.55±10% and may range from −0.605 to −0.495. With respect to the size of the coupling coefficient k, the thickness T1 of the intermediate layer 150, which may be implemented in the range of 0.495 to 0.605, was simulated while varying the relative permeability, and Table 1 below lists the simulation data.

When the size of the implemented coupling coefficient k satisfied the range of 0.495 to 0.605, the sample was marked “OK” in the Determination column, and when the size was beyond the reference range, the sample was marked “NG” in the Determination column.

TABLE 1

| Intermediate | | | | | | | | |
|---|---|---|---|---|---|---|---|---|
| layer | Coupling | | Coupling | | Coupling | | Coupling | |
| thickness | coefficient | | coefficient | | coefficient | | coefficient | |
| (T1, μm) | k (μ = 36) | Determination | k (μ = 18) | Determination | k (μ = 9) | Determination | k (μ = 3) | Determination |
| 1 | 0.50873 | OK | 0.52695 | OK | 0.53071 | OK | 0.538 | OK |
| 2 | 0.50484 | OK | 0.52338 | OK | 0.52928 | OK | 0.538 | OK |
| 3 | 0.50095 | OK | 0.51981 | OK | 0.52785 | OK | 0.538 | OK |
| 4 | 0.49706 | OK | 0.51624 | OK | 0.52642 | OK | 0.538 | OK |
| 5 | 0.49317 | NG | 0.51267 | OK | 0.52499 | OK | 0.538 | OK |
| 6 | 0.48928 | NG | 0.5091 | OK | 0.52356 | OK | 0.538 | OK |
| 7 | 0.48539 | NG | 0.50553 | OK | 0.52213 | OK | 0.538 | OK |
| 8 | 0.4815 | NG | 0.50196 | OK | 0.5207 | OK | 0.538 | OK |
| 9 | 0.47761 | NG | 0.49839 | OK | 0.51927 | OK | 0.538 | OK |
| 10 | 0.47372 | NG | 0.49582 | OK | 0.51784 | OK | 0.538 | OK |
| 11 | 0.46983 | NG | 0.49125 | NG | 0.51641 | OK | 0.538 | OK |
| 12 | 0.46594 | NG | 0.48768 | NG | 0.51498 | OK | 0.538 | OK |
| 13 | 0.46205 | NG | 0.48411 | NG | 0.51355 | OK | 0.538 | OK |
| 14 | 0.45816 | NG | 0.48054 | NG | 0.51212 | OK | 0.538 | OK |
| 15 | 0.45427 | NG | 0.47697 | NG | 0.51069 | OK | 0.538 | OK |
| 16 | 0.45038 | NG | 0.4734 | NG | 0.50926 | OK | 0.538 | OK |
| 17 | 0.44649 | NG | 0.46983 | NG | 0.50783 | OK | 0.538 | OK |
| 18 | 0.4426 | NG | 0.46626 | NG | 0.5064 | OK | 0.538 | OK |
| 19 | 0.43871 | NG | 0.46269 | NG | 0.50497 | OK | 0.538 | OK |
| 20 | 0.43482 | NG | 0.45912 | NG | 0.50354 | OK | 0.538 | OK |
| 21 | 0.43093 | NG | 0.45555 | NG | 0.50211 | OK | 0.538 | OK |
| 22 | 0.42704 | NG | 0.45198 | NG | 0.50068 | OK | 0.538 | OK |
| 23 | 0.42315 | NG | 0.44841 | NG | 0.49925 | OK | 0.538 | OK |
| 24 | 0.41926 | NG | 0.44484 | NG | 0.49782 | OK | 0.538 | OK |
| 25 | 0.41537 | NG | 0.44127 | NG | 0.49639 | OK | 0.538 | OK |
| 26 | 0.41148 | NG | 0.4377 | NG | 0.49596 | OK | 0.538 | OK |
| 27 | 0.40759 | NG | 0.43413 | NG | 0.49353 | NG | 0.538 | OK |
| 28 | 0.4037 | NG | 0.43056 | NG | 0.4921 | NG | 0.538 | OK |
| 29 | 0.39981 | NG | 0.42699 | NG | 0.49067 | NG | 0.538 | OK |
| 30 | 0.39592 | NG | 0.42342 | NG | 0.48924 | NG | 0.538 | OK |

Referring to Table 1 and FIG. 8, it is indicated that, when the relative permeability of the intermediate layer 150 is 36 and the thickness T1 of the intermediate layer 150 is 4 μm or lower, the coupling coefficient k in the desired range was implemented. Accordingly, the intermediate layer 150 in the embodiment may have relative permeability of 36, and the thickness T1 in the first direction T may be 4 μm or lower.

Also, it is indicated that, when the relative permeability of the intermediate layer 150 is 18 and the thickness T1 of the intermediate layer 150 was 10 μm or lower, the coupling coefficient k in the desired range was implemented. Accordingly, the intermediate layer 150 in the embodiment may have relative permeability of 18, and the thickness T1 in the first direction T may be 10 μm or lower.

Also, when the relative permeability of the intermediate layer 150 is 9, and the thickness T1 of the intermediate layer 150 is 26 μm or lower, the coupling coefficient k in the desired range was implemented. Accordingly, the intermediate layer 150 in the embodiment may have relative permeability of 9, and the thickness T1 in the first direction T may be 26 μm or lower.

When the relative permeability of the intermediate layer 150 is 3, the size of the coupling coefficient k was implemented in the desired range of 0.495 to 0.605, irrespective of the thickness T1 of the intermediate layer 150.

Considering the trend of coupling coefficient k depending on changes in relative permeability of the intermediate layer 150, the coupling coefficient k in the desired range may be implemented when the relative permeability of the intermediate layer 150 is 3 or less, irrespective of the thickness T1.

Here, the thickness of the intermediate layer T1 may be an arithmetic average of at least three values among dimensions of a plurality of line segments connecting two outermost boundary lines of the intermediate layer 150, opposing each other in the thickness direction T, to each other in parallel to the thickness direction T and spaced apart from each other in the second direction W, with respect to an optical microscope image or a scanning electron microscope (SEM) image with respect to a cross-section in the length direction L-thickness direction T taken from the central portion of the coil component 1000 taken in the width direction W. Here, the plurality of line segments parallel to the thickness direction T may be spaced apart from each other by an equal distance in the second direction W, but an embodiment thereof is not limited thereto.

When it is difficult to measure permeability of the intermediate layer 150 in the state of coil component 1000, permeability may be compared by analyzing the type of magnetic material, the size of particles, the filling rate of particles, or the like, included in the intermediate layer 150 and the region of the body 100 other than the intermediate layer 150.

Hereinafter, an example in which permeability of the intermediate layer 150 is lower than permeability of the other region of the body 100 may be described in terms of the filling rate of magnetic particles with reference to FIGS. 4 to 7.

FIG. 4 is an enlarged diagram illustrating region A in FIG. 3, illustrating the example in which the other region of the body 100 is filled with magnetic particles. FIG. 5 is an enlarged diagram illustrating region B in FIG. 3, the example in which the intermediate layer 150 included in the body 100 is filled with magnetic particles.

Referring to FIG. 4, region A, that is, the region of the body 100 other than the intermediate layer 150, may include magnetic particles P11, and an insulating material R1 such as resin may be interposed between the magnetic particles P11.

Referring to FIG. 5, region B, that is, one region of the intermediate layer 150, may include magnetic particles P21, where an insulating material R2 such as resin may be interposed between the magnetic particles P21.

As illustrated, a filling rate of the magnetic particles P11 of region A may be higher than a filling rate of the magnetic particles P21 of region B. As an example of a method of obtaining the filling rate, SEM images of region A and region B may be obtained, and the ratio of the area occupied by the magnetic particles P11 and P21 in the entire area may be calculated, and in this case, to obtain a more accurate value, the filling rate value may be obtained from a plurality of cross-section. Other methods and/or tools appreciated by one of ordinary skill in the art, even if not described in the present disclosure, may also be used.

When there is no significant difference in sizes of the magnetic particles P11 and P21 in region A and region B, for example, the difference between D50 of magnetic particles P11 in region A and D50 of magnetic particles P21 in region B is 10% or lower, the filling rate of the magnetic particles P11 and P21 may affect permeability in the corresponding region. Here, the difference in D50 being 10% or lower may indicate that the ratio of the difference between large and small values of D50 to the large value of D50 may be 10% or lower. As an example, the magnetic particles P11 included in region A may have a diameter ranging from 5 μm to 61 μm, and similarly, the magnetic particles P21 included in region B may have a diameter ranging from 5 μm to 61 m.

To increase the filling rate of magnetic particles, magnetic particles having different distributions of particle sizes may be used. That is, region A may include two or more types of magnetic particles having different sizes of D50. FIG. 6 illustrates a modified example A′ using two types of particles P11 and P12, and FIG. 7 illustrates modified example A″ using three types of particles P11, P12, and P13. By using a plurality of magnetic particles having different sizes of D50 as described above, the filling rate of magnetic particles may be improved, and accordingly, permeability of the region may be increased. D50 may be measured from scanning electron microscope (SEM) images. Other methods and/or tools appreciated by one of ordinary skill in the art, even if not described in the present disclosure, may also be used.

In modified examples A′ and A″ illustrated in FIGS. 6 and 7, the first magnetic particles P11 may have a diameter range of 5 μm to 61 μm, the second magnetic particles P12 may have a diameter range of 0.9 μm to 4.5 μm, and the third magnetic particles P13 may have a diameter range from 10 nm to 800 nm.

The diameter of magnetic particles P11, P12, P13, and P21 present in the intermediate layer 150 may be measured in a cross-section of the intermediate layer 150. Specifically, a plurality of regions (e.g., 5 or 10 regions) at an equal distance in the second direction W may be imaged using a scanning electron microscope with respect to the L-T cross-section passing through the center of the body 100, and the diameters of magnetic particles P11, P12, P13, and P21 may be obtained using an image analysis program. In this case, as a specific example, the image pixel size in the SEM image may be fixed to nm*10 nm and the working distance may be fixed to 8 μmm. Thereafter, the average value of the diameter may be calculated using an image analysis program (e.g. ORS Deep learning tool).

The magnetic particles P11, P12, P13, and P21 may have a spherical or substantially spherical shape, but an embodiment thereof is not limited thereto. That is, the magnetic particles P11, P12, P13, and P21 may have a non-spherical shape. The shape may be obtained as sphericity of the magnetic particles P11, P12, P13, and P21 decreases during an oxidation process. When the magnetic particles P11, P12, P13, and P21 are arbitrary shapes not maintaining a spherical shape, the above-mentioned diameter may be interpreted by replacing the same with the Feret diameter, and the average value of the diameter may also be interpreted by replacing the same with the average value of the Feret diameter. As a method of calculating the diameter average value, a tool in image process software may be used, and the size distribution may be obtained through particle size analysis for each region.

In the above describe, the diameter of the magnetic particles P11, P12, P13, and P21 may be measured based on the plurality of cross-sections from the coil component 1000, but when it is difficult to take the plurality of cross-section, one cross-section, for example, the diameter may be measured at the L-T cross-section or the W-T cross-section passing through the center of the body 100.

In the embodiment described above, permeability of the intermediate layer 150 may be adjusted by adjusting the filling rate of magnetic particles in the body 100, but differently from this, the intermediate layer 150 region (region B) and the other region of the body 100 (region B) of the body 100 may have a different material included in the magnetic particles, and accordingly, permeability may be adjusted.

Specifically, the body 100 may include an Fe-based alloy, and in the body 100, the Fe-based alloy included in the intermediate layer 150 region (region B) and the Fe-based alloy included in the other region (region A) other than the intermediate layer 150 may have different compositions. In this case, the Fe-based alloy included in the intermediate layer 150 region (region B) may have a less content of Fe than the Fe-based alloy included in the other region (region A) of the body 100, where the content of Fe may be wt %.

Also, considering that Si, in addition to Fe, may also affect permeability, the content of Si may also be adjusted together with or independently of Fe. For example, the Fe-based alloy included in the body 100 may be an Fe—Si-based alloy, and the Fe—Si-based alloy included in the intermediate layer 150 region (region B) in the body 100 may have a less content of Si than the Fe—Si-based alloy included in the other region (region A) of the body 100.

Specifically, the content of Si in the Fe—Si-based alloy included in the intermediate layer 150 region (region B) in the body 100 may be less than 6.5 wt %, based on, for example, a total weight of the Fe—Si-based alloy, and the content of Si included in the other region (region A) of the body 100 in Fe—Si-based alloy may be 6.5 wt % or more, based on, for example, a total weight of the Fe—Si-based alloy. More specifically, the content of Si in the Fe—Si-based alloy included in the intermediate layer 150 may be lwt % or more 5 wt % or lower. Also, when the Fe-based alloy included in the intermediate layer 150 region (region B) in the body 100 and the Fe-based alloy included in the other region (region A) of the body 100 have different compositions, the types of elements included therein may be different. For example, the elements included in the Fe-based alloy of the intermediate layer 150 region (region B) in the body 100 may not be included in the Fe-based alloy of the other region (region A) of the body 100, or vice versa.

The contents of the elements in the alloys disclosed herein may be measured by scanning electron microscopy coupled with energy-dispersive X-ray spectroscopy (SEM-EDX) or Inductively coupled plasma mass spectrometry (ICP-MS). Other methods and/or tools appreciated by one of ordinary skill in the art, even if not described in the present disclosure, may also be used.

Differently from the previous embodiment, the intermediate layer 150 may be implemented in the form of a sheet rather than magnetic particles. That is, the intermediate layer 150 may include a magnetic sheet, where the magnetic sheet may include ferrite. In this case, region A may include magnetic particles formed of Fe-based alloy, which has relatively higher permeability than permeability of ferrite.

In some embodiments, the relative permeability of the intermediate layer 150 may be measured by methods and/or tools appreciated by one of ordinary skill in the art. In some embodiments, the relative permeability of the intermediate layer 150 may be related to the relative permeability of the powder(s) from which the intermediate layer 150 was prepared. The relative permeability of the powder(s) may be measured by forming a ring-shaped core sample from the powder(s), winding a wire around the sample, and measuring the inductance. Other methods and/or tools appreciated by one of ordinary skill in the art, even if not described in the present disclosure, may also be used.

Referring to FIGS. 1 to 3, the coil component 1000 according to the embodiment may include a first coil 200 and a second coil 300 magnetically coupled to each other.

The first and second coils 200 and 300 may be buried in the body 100 and may exhibit the properties of the coil component 1000. For example, when the coil component 1000 according to the embodiment is used as a power inductor, the first and second coils 200 and 300 may function to stabilize the power of an electronic device by storing the electric field as a magnetic field and maintaining an output voltage. Also, overall inductance capacitance may be adjusted by adjusting the coupling coefficient k between the first and second coils 200 and 300.

Referring to FIGS. 1 to 3, the first coil 200 and the second coil 300 may be spaced apart from each other in the first direction T.

The first coil 200 may include a first coil pattern 210 having at least one turn with respect to the first core 110, a first lead-out portion 230 extending from the first coil pattern 210 and connected to the first external electrode 410, a first connection pattern 240, spaced apart from the first coil pattern 210 and connected to the second external electrode 420, and a first via 220 connecting an inner end of the first coil pattern 210 to the first connection pattern 240.

Also, the second coil 300 may include a second coil pattern 310 having at least one turn with respect to the second core 120, a second lead-out portion 330 extending from the second coil pattern 310 and connected to the third external electrode 430, a second connection pattern 340 spaced apart from the second coil pattern 310 and connected to the fourth external electrode 440, and a second via 320 connecting an inner end of the second coil pattern 310 to the second connection pattern 340.

Referring to FIGS. 1 to 3, each of the first and second coil patterns 210 and 310 in the embodiment may have a single layer structure.

Specifically, the first lead-out portion 230 of the first coil 200 may be disposed at the same level as the first coil pattern 210, and the first connection pattern 240 may be disposed at the same level as the second coil pattern 310. That is, the first coil pattern 210, the first lead-out portion 230, and the second connection pattern 340 may be disposed in the region between the intermediate layer 150 and the first surface 101 of the body 100.

Also, the inner end of the first coil pattern 210 and the first connection pattern 240 may be connected to each other by the first via 220, and the first via 220 may penetrate the intermediate layer 150.

Similarly, the second lead-out portion 330 of the second coil 300 may be disposed at the same level as the second coil pattern 310, and the second connection pattern 340 may be disposed at the same level as the first coil pattern 210. That is, the second coil pattern 310, the second lead-out portion 330, and the first connection pattern 240 may be disposed in a region between the intermediate layer 150 and the second surface 102 of the body 100.

Also, the inner end of the second coil pattern 310 and the second connection pattern 340 may be connected to each other by the second via 320, and the second via 320 may penetrate the intermediate layer 150.

By this structure, when the coil component 1000 according to the embodiment is mounted on the circuit board, the signal input to the first external electrode 410 may pass through the first lead-out portion 230, the first coil pattern 210, the first via 220, and the first connection pattern 240 and may be output to the second external electrode 420.

Also, the signal input to the third external electrode 430 may pass through the second lead-out portion 330, the second coil pattern 310, the second via 320, and the second connection pattern 340 and may be output to the fourth external electrode 440.

Accordingly, the first coil 200 may function as a coil between the first external electrode 410 and the second external electrode 420, and the second coil 300 may function as a coil between the third external electrode 430 and the fourth external electrode 440.

Also, the first coil 200 and the second coil 300 may be magnetically coupled to each other, and positive coupling or negative coupling may be implemented depending on the input and output directions connected to the external electrodes 410, 420, 430, and 440.

The first and second coils 200 and 300 may be plating patterns formed using a plating process generally used, for example, a method such as pattern plating, anisotropic plating, and isotropic plating, and may be formed into a multilayer structure using a plurality of processes among the processes. Examples of materials of the first and second coils 200 and 300 may include a conductive material such as copper (Cu), aluminum (Al), silver (Ag), tin (Sn), gold (Au), nickel (Ni), lead (Pb), titanium (Ti), chromium (Cr), molybdenum (Mo) or alloys thereof, but an embodiment thereof is not limited thereto.

Referring to FIG. 3, the coil component 1000 according to the embodiment may include an insulating film IF covering the coils 200 and 300.

The insulating film IF may be formed along surfaces of the first and second coils 200 and 300, and may be disposed between the first and second coils 200 and 300 and the body 100.

The insulating film IF when may be configured to insulate the first and second coils 200 and 300 from the body 100, and may include a generally used insulating material such as parylene, but an embodiment thereof is not limited thereto. The insulating film IF may be formed by a method such as vapor deposition, but an embodiment thereof is not limited thereto, and the insulating film IF may be formed by laminating insulating films.

The insulating film in the embodiment may not be provided when the component of the body 100 has sufficient insulation properties.

Referring to FIGS. 1 and 2, the coil component 1000 according to the embodiment may include external electrodes 410, 420, 430, and 440 disposed on the body 100 and connected to the first and second coils 200 and 300.

The external electrodes 410, 420, 430, and 440 may be configured to electrically connect the coil component 1000 to the circuit board when the coil component 1000 according to the embodiment is mounted on a circuit board. For example, the first to fourth external electrodes 410, 420, 430, and 440 spaced apart from each other on the second surface 102 of the body 100 and the connection portion of the circuit board may be electrically connected to each other.

The first external electrode 410 and the second external electrode 420 may be spaced apart from the third surface 103 of the body 100, the first external electrode 410 may be connected to the first lead-out portion 230, and the second external electrode 420 may be connected to the first connection pattern 240.

Also, the third external electrode 430 and the fourth external electrode 440 may be spaced apart from the fourth surface 104 of the body 100, the third external electrode 430 may be connected to the second lead-out portion 330, and the fourth external electrode 440 may be connected to the second connection pattern 340.

At least a portion of each of the first to fourth external electrodes 410, 420, 430, and 440 may extend to the second surface 102, a mounting surface.

The external electrodes 410, 420, 430, and 440 may be formed of a conductive material such as copper (Cu), aluminum (Al), silver (Ag), tin (Sn), gold (Au), nickel (Ni), lead (Pb), chromium (Cr), titanium (Ti), or alloys thereof, but an embodiment thereof is not limited thereto.

The external electrodes 410, 420, 430, and 440 may be formed in a plurality of layers. For example, the external electrodes 410, 420, 430, and 440 may include a first layer in contact with the lead-out portions 230 and 330 or the connection patterns 240 and 340, and a second layer disposed on the first layer. Here, the first layer may be a conductive resin layer including conductive powder including at least one of copper (Cu) and silver (Ag) and an insulating resin, or may be a copper (Cu) plating layer. The second layer may have a double-layer structure, such as a nickel (Ni) plating layer and a tin (Sn) plating layer.

Referring to FIG. 3, the coil component 1000 according to the embodiment may further include an insulating layer 500 covering an external side surface of body 100, disposed in a region other than the region in which the external electrodes 410, 420, 430, and 440 are disposed, and exposing the external electrodes 410, 420, 430, and 440.

For example, the insulating layer 500 may be formed by applying and curing an insulating material including an insulating resin to the surface of the body 100. In this case, the insulating layer may include at least one of thermoplastic resins such as polystyrene-based resin, vinyl acetate-based resin, polyester-based resin, polyethylene-based resin, polypropylene-based resin, polyamide-based resin, rubber-based resin, and acrylic-based resin, thermosetting resins such as phenol-based resin, epoxy-based resin, urethane-based resin, melamine-based resin, and alkyd-based resin, and photosensitive insulating resin.

### Second Embodiment

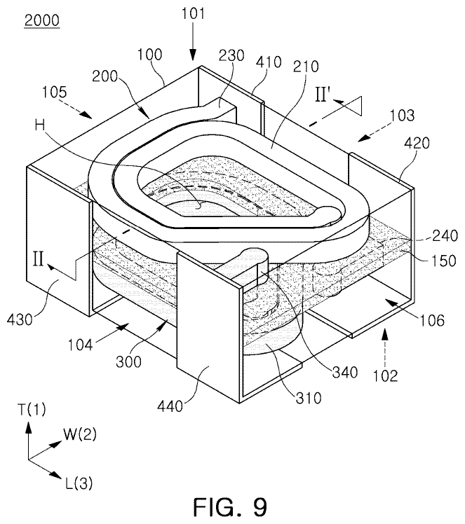

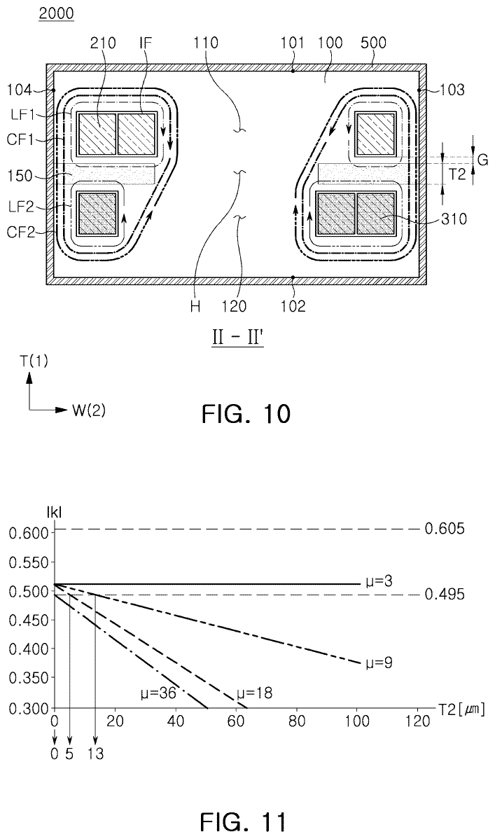

FIG. 9 is a perspective diagram illustrating a coil component according to a second embodiment. FIG. 10 is a cross-sectional diagram taken along line II-II′ in FIG. 9. FIG. 11 is a graph of coupling coefficient k depending on relative permeability and a thickness of an intermediate layer in a second embodiment.

Comparing FIG. 9 with FIG. 1 and FIG. 10 with FIG. 3, the intermediate layer 150 in the embodiment may be different in that a through-hole H may be formed in a central region to physically connect the first core 110 to the second core 120.

Accordingly, when describing the embodiment, only the form of the intermediate layer 150 and the connection between the first and second cores 110 and 120 will be described, which are different from the first embodiment. The descriptions of the first embodiment may be applied to the other components in the embodiment.

Referring to FIGS. 9 and 10, the intermediate layer 150 in the embodiment may include the through-hole H formed along a region in which the first core 110 and the second core 120 overlap each other in the first direction T.

The region of the intermediate layer 150 in which the through-hole H is formed may be filled with the same components as in the other region of the body 100, such that the region may have higher permeability than the intermediate layer 150.

Accordingly, the first and second cores 110 and 120 may be physically connected to each other in a portion of region by the through-hole H, such that the flow of magnetic flux in the region between the first and second cores 110 and 120 among the coupled path CF1 and CF2 flowing around the entirety of the first coil 200 and the second coil 300 may be smoothened, and accordingly, the saturation current Iₛₐₜ properties of the coil component 2000 may be improved.

The intermediate layer 150 in the embodiment may have lower permeability than permeability of the other region of the body 100. As an example, although not limited thereto, relative permeability of the intermediate layer 150 may have a value less than 18.

In the coil component 2000 according to the embodiment, the desired coupling coefficient k may be-0.55±10% and may range from −0.605 to −0.495. With respect to the size of the coupling coefficient k, the thickness T2 of the intermediate layer 150 implemented in the range of 0.495 to 0.605 was simulated while varying the relative permeability, and FIG. 11 is a graph indicating the simulation results.

Referring to FIG. 11, it is indicated that when the relative permeability of the intermediate layer 150 is 36, the coupling coefficient k in the desired range was not implemented irrespective of the thickness T2 of the intermediate layer 150.

When the relative permeability of the intermediate layer 150 is 18 and the thickness T2 of the intermediate layer 150 was 5 μm or lower, the coupling coefficient k in the desired range was implemented. Accordingly, the intermediate layer 150 in the embodiment had relative permeability of 18, and the thickness T2 in the first direction T was 5 μm or lower.

Also, when the relative permeability of the intermediate layer 150 is 9, and the thickness T2 of the intermediate layer 150 is 13 μm or lower, the coupling coefficient k in the desired range was implemented. Accordingly, the intermediate layer 150 in the embodiment had relative permeability of 9, and the thickness T2 in the first direction T was 13 μm or lower.

When the relative permeability of the intermediate layer 150 is 3, the size of the coupling coefficient k was implemented in the desired range of 0.495 to 0.605, irrespective of the thickness T2 of the intermediate layer 150.

Considering the graph of the coupling coefficient k depending on changes in relative permeability of the intermediate layer 150, when the relative permeability of the intermediate layer 150 is 3 or less, the coupling coefficient k in the desired range may be implemented irrespective of the thickness T2.

### Third Embodiment

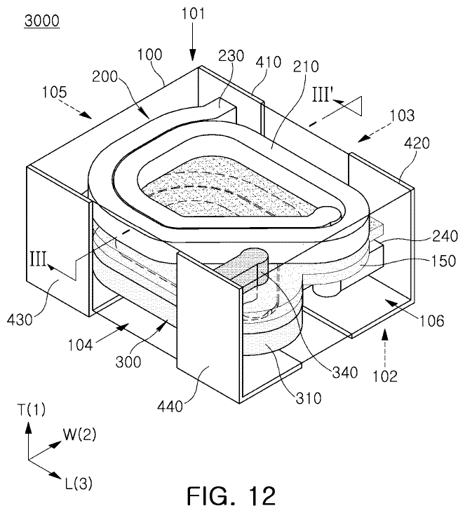

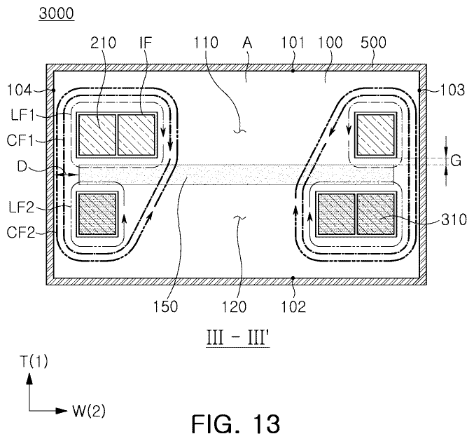

FIG. 12 is a perspective diagram illustrating a coil component according to a third embodiment. FIG. 13 is a cross-sectional diagram taken along line III-III′ in FIG. 12.

When comparing FIG. 12 with FIG. 1 and FIG. 13 with FIG. 3, the configuration in which the outer region of the intermediate layer 150 may be partially removed and may be spaced apart from the side surface of the body 100 may be different.

Accordingly, when describing the embodiment, only the outer region of the intermediate layer 150, different from the first embodiment, will be described. The descriptions of the first embodiment may be applied to the other components in the embodiment.

Referring to FIGS. 12 and 13, at least a portion of the intermediate layer 150 in the embodiment may be spaced apart from the side surface of the body 100, that is, the third surface to sixth surface 103, 104, 105, and 106 at a predetermined distance D.

The region in which the intermediate layer 150 is spaced apart from the side surface of the body 100 may be filled with the same component as the other region of the body 100, such that the region may have higher permeability than permeability of the intermediate layer 150.

Accordingly, the flow of magnetic flux in the outer region, flowing around the entirety of the first coil 200 and the second coil 300, in the coupled path CF1 and CF2 in which density of magnetic flux is relatively high may be smoothened, and accordingly, saturation current Iₛₐₜ properties of the coil component 3000 may be improved.

### Fourth Embodiment

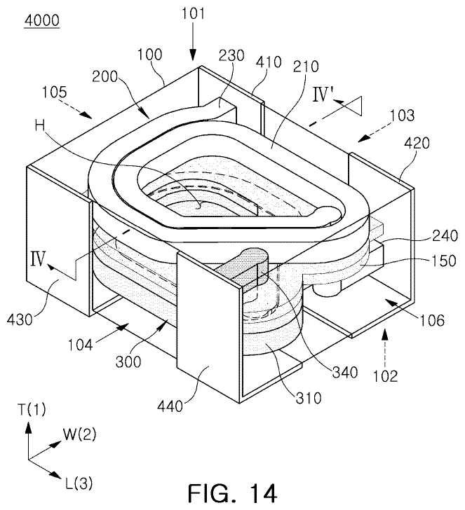

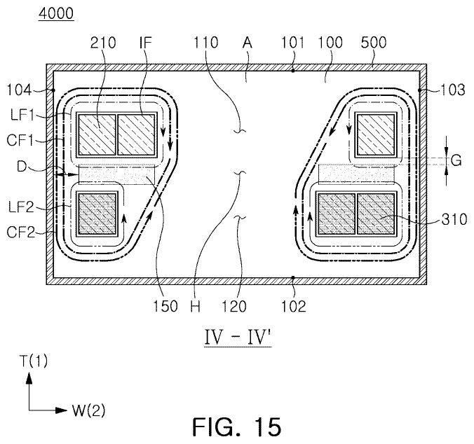

FIG. 14 is a perspective diagram illustrating a coil component according to a fourth embodiment. FIG. 15 is a cross-sectional diagram taken along line IV-IV′ in FIG. 14.

Comparing FIG. 14 with FIG. 1 and FIG. 15 with FIG. 3, the configuration in which a through-hole H is formed in the center of the intermediate layer 150, and the outer region of the intermediate layer 150 may be partially removed and may be spaced apart from the side surface of the body 100 may be different.

Accordingly, when describing the embodiment, only the through-hole H and the outer region of the intermediate layer 150, different from the first embodiment, will be described. The descriptions of the first embodiment may be applied to the other components in the embodiment.

Referring to FIGS. 14 and 15, the intermediate layer 150 in the embodiment may include the through-hole H formed along a region in which the first core 110 and the second core 120 overlap each other in the first direction T, and at least a portion of the intermediate layer 150 may be spaced apart from the side surface of the body 100, that is, the third surface to the sixth surface 103, 104, 105, and 106, at a predetermined distance D.

The region of the intermediate layer 150 in which the through-hole H is formed and the region spaced apart from the side surface of the body 100 may be filled with the same component as in the other region of the body 100, such that the regions may have permeability higher than permeability of the intermediate layer 150.

Accordingly, the first and second cores 110 and 120 may be physically connected to each other in a portion of region by the through-hole H, such that the flow of magnetic flux flowing around the entirety of the first coil 200 and the second coil 300 in the region between first and second cores 110 and 120 in the coupled paths CF1 and CF2 may be smoothened, and the flow of magnetic flux may be smoothed in the outer region in which density of magnetic flux is relatively high, such that saturation current Iₛₐₜ properties of the coil component 4000 may be improved.

### Fifth Embodiment and Modified Example Thereof

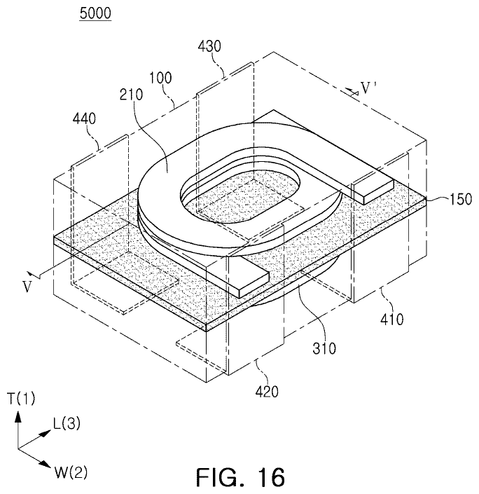

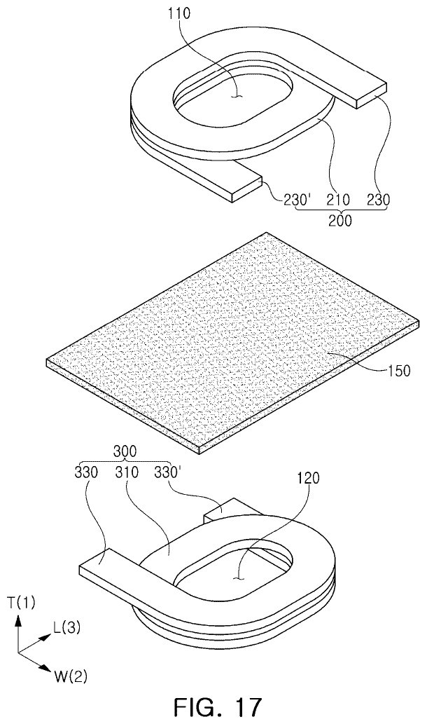

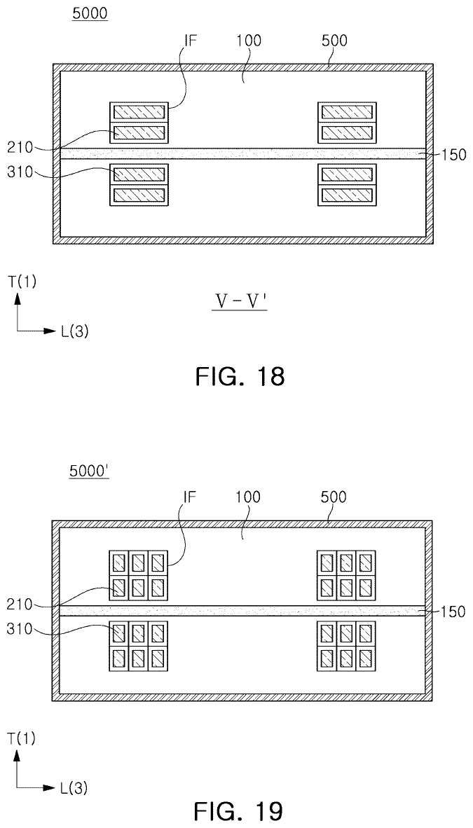

FIG. 16 is a perspective diagram illustrating a coil component according to a fifth embodiment. FIG. 17 is an exploded perspective diagram of some of the components illustrated in FIG. 16. FIG. 18 is a cross-sectional diagram taken along line V-V′ in FIG. 16.

Comparing FIGS. 16 to 18 with FIGS. 1 to 3, in the coil component 5000 according to the embodiment, the shapes of the coils 200 and 300 disposed in the body 100 may be different.

Accordingly, when describing the embodiment, only the coils 200 and 300 different from the first embodiment will be described. The descriptions of the first embodiment may be applied to the other components in the embodiment.

Referring to FIGS. 16 to 18, the coils 200 and 300 forming turns in the embodiment may be formed in a plurality of layers on the L-T cross-section.

The first coil 200 may include a first coil pattern 210 forming at least one turn, and lead-out portions 230 and 230′ on both ends of the first coil pattern 210. The first coil pattern 210 and the lead-out portions 230 and 230′ may be integrated with each other, and accordingly, differently from the first to fourth embodiment, the first via 220 and the first connection pattern 240 may not be included.

Also, the second coil 300 may include a second coil pattern 310 forming at least one turn, and lead-out portions 330 and 330′ on both ends of the second coil pattern 310. The second coil pattern 310 and the lead-out portions 330 and 330′ may be integrated with each other, and accordingly, differently from the first to fourth embodiment, the second via 320 and the second connection pattern 340 may not be included.

The first and second coils 200 and 300 may have an aspect ratio of less than 1, which indicates the ratio of a line width to a thickness on a cross-section parallel to the first direction T, but an embodiment thereof is not limited thereto.

FIG. 19 is a diagram illustrating a modified example 5000′ of FIG. 18.

Referring to FIG. 19, in the coil component 5000′ according to the modified example, the cross-section of coil patterns 210 and 310 may have a rectangular shape, and the aspect ratio, which indicates the ratio of a line width to a thickness on the cross-section parallel to the first direction T, may be greater than 1, but an embodiment thereof is not limited thereto.

Specifically, in the first and second coil patterns 210 and 310 in the modified example, a pattern having a rectangular shape of which a cross-section aspect ratio is 1 or more may form at least one turn around a winding axis parallel to the first direction T. As an example, the first and second coil patterns 210 and 310 may include a first layer wound by three turns from the outer side to the inner side, and a second layer extending from the first layer and wound by three turns from the inner side to the outer side, but an embodiment thereof is not limited thereto.

When the first and second coil patterns 210 and 310 have the shape described above, it may be easy to increase the number of turns in the limited spaced of the body 100, thereby improving inductance capacitance.

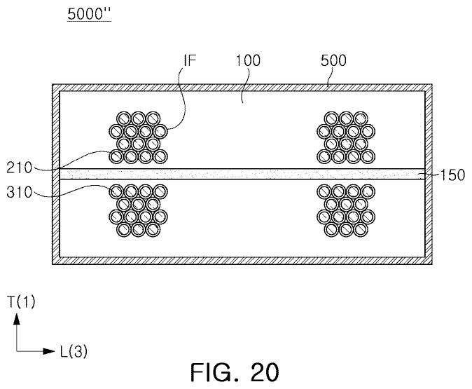

FIG. 20 is a diagram illustrating another modified example 5000″ in FIG. 18.

Referring to FIG. 20, the first and second coil patterns 210 and 310 of the “coil component 5000” according to the modified example may be formed in a circular shape on a cross-section parallel to the first direction T. Accordingly, the insulating film IF insulating the surfaces of the first and second coil patterns 210 and 310 may also be formed in a circular shape on a cross-section parallel to the first direction T.

When the first and second coil patterns 210 and 310 have the shape described above, it may be easy to increase the number of turns in the limited space of the body 100, thereby improving inductance capacitance. Also, since the number of turns and drawing direction of the first and second coils 200 and 300 has a high degree of design freedom, the coupling coefficient may be easily adjusted to the desired coupling coefficient.

According to the aforementioned embodiments, by disposing an intermediate layer having low permeability between two coils of the coupled inductor and adjusting the thickness and position of the intermediate layer, the desired coupling coefficient k may be implemented.

According to another aspect of the present disclosure, by appropriately maintaining the spacing distance between the two coils in the coupled inductor, the decrease in saturation current Iₛₐₜ properties occurring when two coils are close together or the increase in volatility of coupling coefficient k due to errors in process may be alleviated.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including an intermediate layer, the body having a first surface and a second surface opposing each other in a first direction, and a plurality of side surfaces connecting the first surface to the second surface;
a first coil disposed in the body and including a first coil pattern having at least one turn;
a second coil spaced apart from the first coil in the body and including a second coil pattern having at least one turn;
first and second external electrodes disposed on the body and connected to the first coil; and
third and fourth external electrodes disposed on the body and connected to the second coil,
wherein the intermediate layer has permeability lower than permeability of the other region of the body, is disposed between the first coil and the second coil, and is spaced apart from each of the first coil and the second coil.

2. The coil component of claim 1, wherein at least one of the first coil pattern and the second coil pattern is a single layer.

3. The coil component of claim 1, wherein at least a portion of the intermediate layer extends to a side surface of the body.

4. The coil component of claim 3, wherein a size of a coupling coefficient k between the first coil and the second coil is 0.495 or more and 0.605 or less.

5. The coil component of claim 4, wherein relative permeability of the intermediate layer is 3 or less.

6. The coil component of claim 4, wherein relative permeability of the intermediate layer is 9, and a thickness of the intermediate layer in the first direction is 26 μm or lower.

7. The coil component of claim 4, wherein relative permeability of the intermediate layer is 18, and a thickness of the intermediate layer in the first direction is m or lower.

8. The coil component of claim 4, wherein relative permeability of the intermediate layer is 36, and a thickness of the intermediate layer in the first direction is 4 μm or lower.

9. The coil component of claim 3,
wherein the body further includes a first core filling a central region of the first coil pattern, and a second core filling a central region of the second coil pattern, and
wherein the intermediate layer includes a through-hole along a region in which the first core and the second core overlap each other in the first direction.

10. The coil component of claim 9, wherein the first and second cores include a first region in which the first and second cores overlap each other in the first direction and a second region in which the first and second cores do not overlap each other in the first direction.

11. The coil component of claim 1, wherein at least a portion of the intermediate layer is spaced apart from a side surface of the body.

12. The coil component of claim 11,
wherein the body further includes a first core filling a central region of the first coil pattern, and a second core filling a central region of the second coil pattern, and
wherein the intermediate layer includes a through-hole along a region in which the first core and the second core overlap each other in the first direction.

13. The coil component of claim 1,
wherein the first coil includes a first lead-out portion extending from the first coil pattern and connected to the first external electrode, a first connection pattern spaced apart from the first coil pattern and connected to the second external electrode, and a first via connecting an inner end of the first coil pattern to the first connection pattern, and
wherein the second coil includes a second lead-out portion extending from the second coil pattern and connected to the third external electrode, a second connection pattern spaced apart from the second coil pattern and connected to the fourth external electrode, and a second via connecting an inner end of the second coil pattern to the second connection pattern.

14. The coil component of claim 13, wherein at least one of the first via and the second via penetrates the intermediate layer.

15. The coil component of claim 1,
wherein the body includes magnetic particles, and
wherein the intermediate layer has a lower filling rate of the magnetic particles than a filling rate of magnetic particles of the other region of the body.

16. The coil component of claim 1, wherein the other region of the body includes two or more types of magnetic particles of which sizes of D50 are different.

17. A coil component, comprising:
a body including an intermediate layer, the body having a first surface and a second surface opposing each other in a first direction, and a plurality of side surfaces connecting the first surface to the second surface;
a first coil disposed in the body, and including a first coil pattern that has at least one turn and that is a single layer;
a second coil spaced apart from the first coil in the body, and including a second coil pattern that has at least one turn and that is a single layer;
first and second external electrodes disposed on the body and connected to the first coil; and
third and fourth external electrodes disposed on the body and connected to the second coil,
wherein the body includes an Fe-based alloy, and an Fe-based alloy included in the intermediate layer in the body and an Fe-based alloy included in the other region of the body other than the intermediate layer have different compositions, and
wherein the intermediate layer is disposed between the first coil and the second coil, and spaced apart from the first coil and the second coil.

18. The coil component of claim 17, wherein the Fe-based alloy included in the intermediate layer has a content of Fe lower than a content of Fe of the Fe-based alloy included in the other region of the body.

19. The coil component of claim 17, wherein the Fe-based alloy included in the body is an Fe—Si-based alloy, and an Fe—Si-based alloy included in the intermediate layer has a content of Si lower than a content of Si in an Fe—Si-based alloy included in the other region of the body.

20. The coil component of claim 19, wherein the content of Si in the Fe—Si-based alloy included in the intermediate layer is less than 6.5 wt %, and the content of Si in the Fe—Si-based alloy included in the other region of the body is 6.5 wt % or more.

21. The coil component of claim 20, wherein the content of Si in the Fe—Si-based alloy included in the intermediate layer is 1 wt % or more and 5 wt % or lower.
